(19) United States
(12) Patent Application Publication
(10) Pub. No.: US 2024/0391423 A1
(43) Pub. Date: Nov. 28, 2024

(54) Control of a Motor Vehicle

(71) Applicant: Bayerische Motoren Werke Aktiengesellschaft, Muenchen (DE)

(72) Inventors: Thorsten KNOTT, Tuntenhausen (DE); Christian LEMKEMEYER, Muenchen (DE)

(21) Appl. No.: 18/645,910

(22) Filed: Apr. 25, 2024

(30) Foreign Application Priority Data
May 26, 2023 (DE) 10 2023 113 930.4

(51) Int. Cl. B60R 25/24; B60R 25/40; H04B 5/77; H04L 9/32; H04W 12/06

(52) U.S. Cl. CPC B60R 25/246; B60R 25/40; H04B 5/77; H04L 9/3271; H04W 12/06; B60R 2325/103

(57) ABSTRACT

An apparatus for controlling a motor vehicle includes: a wireless interface for communicating with an external device; a memory in which a public digital key of the device is stored; an interface to a control apparatus of the motor vehicle; and a processing device. The processing device is configured to detect a request from the device for one-sided authentication; to perform a method for authenticating the device to the motor vehicle on the basis of the stored digital key; and to activate the control apparatus if the authentication is successful.

### CROSS REFERENCE TO RELATED APPLICATIONS

This application claims priority under 35 U.S.C. § 119 from German Patent Application No. DE 10 2023 113 930.4, filed May 26, 2023, the entire disclosure of which is herein expressly incorporated by reference.

This application contains subject matter related to U.S. application Ser. No. ______, entitled “Control of a Motor Vehicle,” filed on even date herewith (Attorney Docket No. 080437.PH571US).

### BACKGROUND AND SUMMARY

The present invention relates to the control of a motor vehicle. In particular, the invention relates to the control of a motor vehicle by means of an external device.

A motor vehicle comprises a locking system that can prevent unauthorized entry to an interior of the motor vehicle. The locking system can be controlled wirelessly, for example using a smartphone connected to the motor vehicle via a wireless Bluetooth or NFC interface. An application can be installed on the smartphone that allows a user to select and control a function of the motor vehicle. For example, individual motor vehicle doors or hatches can be locked or unlocked.

To permit control, cryptographic methods are used that utilize asymmetric key pairs. Usually, this is accomplished by carrying out a two-sided authentication between the motor vehicle and the mobile phone based on the private key material of both parties.

The motor vehicle can be controlled using a technology known as the Digital Car Key, which is specified by the Car Connectivity Consortium (CCC). This technology allows both the motor vehicle to authenticate itself to the smartphone and the smartphone to authenticate itself to the motor vehicle.

On the motor vehicle side, a private digital key is stored in a secure memory that is managed by a central security device. If the security device does not work, for example because a power supply is not available on board the motor vehicle, the motor vehicle cannot be accessed in the manner described. On the other hand, allowing access to the motor vehicle without authenticating it to the smartphone can pose a security risk.

An object underlying the present invention is to provide an improved technique for controlling a motor vehicle by means of an external device. The invention achieves this object by means of the subject matter of the independent claims. Preferred embodiments are described in the dependent claims.

An apparatus for controlling a motor vehicle comprises a wireless interface for communicating with an external device; a memory in which a public digital key of the device is stored; an interface to a control apparatus of the motor vehicle; and a processing device. The processing device is configured to detect a request from the device for one-sided authentication; to perform an authentication of the device to the motor vehicle on the basis of the stored digital key; and to activate the control apparatus if the authentication is successful.

Storing the public digital key of the device in the memory of the apparatus cannot pose a security risk. There is no need to store a private digital key of the motor vehicle that would be required in order to authenticate the motor vehicle to the external device, so there is no risk of the private key being compromised.

The processing device is preferably configured to waive the authentication of the motor vehicle to the device only if the request has been recorded or detected. The apparatus can be used to control a function of the motor vehicle even if the authentication of the motor vehicle is not possible. The memory of the apparatus can be secured so that read or write access by a third party is prevented. Information can be stored in encrypted form in the memory. However, it is not absolutely necessary for the memory to be secured, as information that is stored there as part of the proposed method is public (public keys).

Preferably, the request comprises a vehicle function to be controlled by the apparatus. By indicating the specific vehicle function, the one-sided authentication can be better controlled or initiated. A circumstance, for example the existence of a wireless connection between the device and the motor vehicle, no longer needs to be interpreted by the apparatus on board the motor vehicle. Different vehicle functions that can be requested can be predetermined.

The apparatus can be configured to control a predetermined control function or vehicle function, and performance of the vehicle function can be requested as part of the one-sided authentication. In particular, the vehicle function can permit or prevent physical entry to an interior of the motor vehicle. In one embodiment, the control apparatus is configured to unlock a physical entry to an interior of the motor vehicle. Entry can be through a door, hatch or cover, for example, and the control apparatus can lock or unlock the entry. Entry can also be permitted if an important function of the motor vehicle, in particular a driving function, is not available. This means that the vehicle function can be controlled even in the event of a fault in the motor vehicle.

It is preferable that the authentication takes place by means of a challenge-response method. A random number, possibly together with other information, can thus be transmitted from one participant to another, signed there and the signature transmitted back. The signature can be valid only if the second participant has a predetermined secret. The challenge-response method more preferably uses asymmetric keys.

Preferably, the wireless interface comprises an NFC interface. The processing device can be operated by means of electrical energy drawn from the NFC interface. This allows the apparatus to be more self-sufficient and not dependent on a power supply from the motor vehicle. In addition, NFC (Near Field Communication) works only over short distances, making it difficult for another device to communicate with the motor vehicle illegitimately.

The apparatus can be configured to be operated by means of electrical energy received via the NFC interface. This energy can be supplied externally, for example by means of a mobile device.

In particular, the stored digital key can be a public key that is associated with the external device. Since the key is public, storing the key in the memory of the apparatus cannot pose a security risk. There is no need to store a private digital key of the motor vehicle that would be required in order to authenticate the motor vehicle to the external device, so there is no risk of the private key being compromised.

The apparatus more preferably comprises an interface to a security device that is configured to authenticate the motor vehicle to the device. The processing device can be configured to waive an authentication of the motor vehicle to the device if the security device is not available.

The security device can comprise a secure memory in which a private key of the motor vehicle is stored. In order to protect the key or use the secure memory, the security device can be designed to be significantly more complex than the apparatus proposed herein. However, if the security device is not available, for example due to a fault or because a power supply to the security device is disrupted, the apparatus can be used for control or to access the motor vehicle.

If the security device is available, an authentication of the motor vehicle to the device usually precedes an authentication of the device to the motor vehicle. If the security device is not available, the motor vehicle cannot be authenticated to the device. In this case, a standard method of mutual authentication between the motor vehicle and the external device can be interrupted or modified.

In normal operation of the access control, the control apparatus can be activated by the security device. If the security device is not available, the control apparatus can be activated by the apparatus described herein. It is preferable that the control apparatus is configured to operate independently of the security device.

A motor vehicle comprises an apparatus as described herein. The motor vehicle preferably comprises a passenger car, a truck or a bus. The motor vehicle can have an interior to which physical access can be controlled by means of the apparatus.

A mobile device comprises a wireless interface, wherein the mobile device is configured to use the interface to send a request for one-sided authentication to an apparatus for controlling a motor vehicle; to authenticate a user to the mobile device; to receive a challenge from the apparatus; to determine a response based on a private digital key; and to transmit the response to the apparatus. A successful authentication of the user can be a prerequisite for access to the private digital key. The private key is associated with the mobile device. The challenge and the response can be parts of a challenge-response authentication.

The mobile device is preferably a device that is associated with the user, in particular a personal device. For example, the mobile device can be a smartphone, a smart watch or a sensor wristband. Alternatively, a fob can also be provided specifically for unlocking the motor vehicle. The mobile device preferably comprises its own power supply that it can use to supply power to the wireless interface. The interface can be configured for communication by means of NFC. The mobile device typically comprises an electronic processing device for performing at least a part of a method as described herein.

Authenticating the user to the mobile device can serve as protection against tracking, for example to prevent a one-sided authentication introduced with malicious intent that runs in the background. The authentication is usually carried out using methods of an operating system running on the mobile device, more preferably using special hardware, for example a sensor for a biometric feature of the user or a secure memory. It is particularly preferable that the user's consent to one-sided authentication is determined before the one-sided authentication is carried out. This can be accomplished by providing the user with an explanation as to why the one-sided authentication is suggested and what data are interchanged in the process.

The challenge and response may be part of a method for authenticating the mobile device to a motor vehicle as described herein. The user can be authenticated to the mobile device on the basis of software or hardware that the mobile device comprises. This can be accomplished by retrieving a secret or a biometric feature of the user, for example.

It is preferable to obtain the user's consent to one-sided authentication. More preferably, the user needs to authenticate themself to the mobile device before the request is made available. In particular, the request may require the use of the private digital key. In one embodiment, the request may include a digital signature created based on the private digital key.

The mobile device can have a secure memory in which its private digital key is stored. The mobile device is more preferably configured to permit access to the key only after successful authentication of the user.

A system comprises an apparatus as described herein and a mobile device as described herein. The system can optionally comprise multiple mobile devices that are configured to control the motor vehicle; or multiple motor vehicles that can be controlled by means of one mobile device. The ability to control a motor vehicle with a mobile device may depend on whether or not the necessary cryptographic keys are available from the motor vehicle or mobile device.

A method of controlling a motor vehicle comprises the steps of establishing a wireless connection between the motor vehicle and an external device; authenticating a user to the external device; one-sided authentication of the device to the motor vehicle; and controlling the motor vehicle.

Part or all of the method may be performed by means of a system as described herein or an apparatus as described herein or a device as described herein. The device may comprise a mobile device. A processing device of the apparatus or device can be electronic. The processing device may comprise a programmable microcomputer or microcontroller, and the method may be in the form of a computer program product with program code means. The computer program product can also be stored on a computer-readable data carrier. Features or advantages of the method can be transferred to the apparatus or mobile device or vice versa.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates an exemplary system; and

FIG. 2 is a flow chart of a method.

### DETAILED DESCRIPTION OF THE DRAWINGS

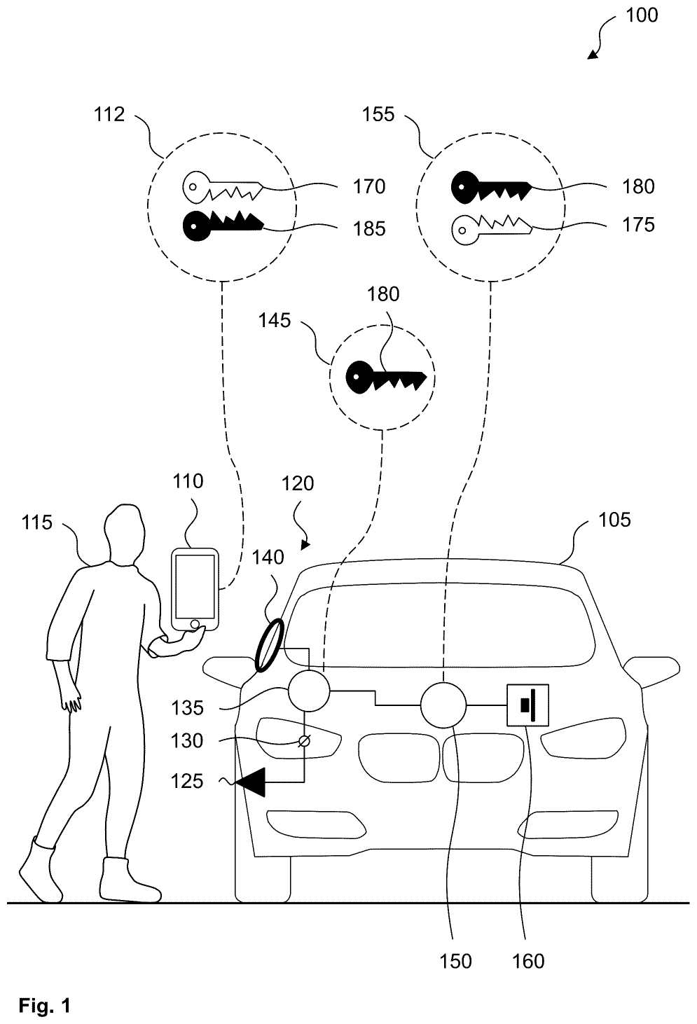

FIG. 1 shows a system 100 comprising a motor vehicle 105 and a device 110 external to the motor vehicle 105. The external device 110 preferably comprises a mobile device, in particular a smartphone, a smart watch or a similar device. The device 110 comprises a memory 112 for storing a digital key, wherein the memory 112 is preferably a secure or secured memory 112 that is protected against unauthorized access. The device 110 may be associated with a human user 115.

The motor vehicle 105 has an apparatus 120 installed on board that is configured to activate a control apparatus 125, which can preferably lock or release a physical entry to an interior of the motor vehicle 105. In the embodiment shown, the control apparatus 125 is configured to unlock a door of the motor vehicle 105. The apparatus 120 can have a self-sufficient power supply and act, for example, on a door lock of the door.

The apparatus 120 is connected to the control apparatus 125 by means of an interface 130 and further comprises a processing device 135, a wireless interface 140 and a memory 145. In particular, the wireless interface 140 can operate according to the NFC standard. Electrical energy thus received via the wireless interface 140 can be supplied to the processing device 135. It may not be necessary for the motor vehicle 105 to supply power to the processing device 135. The memory 145 is preferably a secure memory in which information, in particular a digital key, can be stored in such a way that unauthorized reading or distortion is hampered or prevented.

A security device 150 that has an associated memory 155 may be provided on board the motor vehicle 105. The memory 155 is preferably a secure memory and information stored therein, in particular a cryptographic key, can be protected against reading or modification. The security device 150 can control a variety of security-related functions on board the motor vehicle 105 and use energy from an on-board power supply 160 of the motor vehicle 105. The on-board power supply 160 can comprise an on-board battery, a generator or a voltage converter for supplying energy from a vehicle battery. A variety of different loads can be connected to the on-board power supply 160. The on-board power supply 160 is usually very reliable, but situations are conceivable in which the on-board power supply 160 is not available, meaning inter alia that the security device 150 cannot operate. Other reasons for which the security device 150 is not available are also possible, for example a failure of the security device 150 itself or a failure of an interface between the apparatus 120 and the security device 150.

In order to control the motor vehicle by means of the device 110, a two-sided authentication is usually carried out between the device 110 and the security device 150 of the motor vehicle 105. The authentication is based on a symmetrical encryption method in which each participant has an associated private and public key. As part of the Digital Car Key approach, the authentication can include a standard transaction. In the present case, the security device 150 and the device 110 each have an associated key pair of this kind.

Keys that are associated with the device 110 are shown dark in FIG. 1 and those that are associated with the security device 150 are shown light. Keys with the bit pointing downwards in FIG. 1 are public, and those with the bit pointing upwards are private.

A public key 170 and a private key 175 are associated with the security device 150. A public key 180 and a private key 185 are associated with the device 110. The public key 170 of the security device 150 and the private key 185 of the device 110 are preferably stored in the memory 112 of the device 110. Accordingly, the private key 175 of the security device 150 and the public key 180 of the device 110 are stored in the memory 155 of the security device 150.

Before a person 115 is allowed access to the motor vehicle 105 or before the control apparatus 125 is activated for unlocking, a two-sided authentication based on the private keys 175 and 185 is usually performed. The two-sided authentication can be carried out using a method specified by the Car Connectivity Consortium that is also known as a standard transaction. The standard transaction is described in detail in chapter 7 of the technical specification “Digital Key Release 3” of the Car Connectivity Consortium, version 1.1.0 of Jul. 20, 2022. By using the two-sided authentication, the device 110 can identify the motor vehicle 105 or the security device 150 before revealing its own technical identity in the form of its public key 180 or an identification, so that it can be better protected against digital tracking.

If the security device 150 is not available, for example because the on-board power supply 160 has failed, the apparatus 120 can be activated to nevertheless provide secure access to the motor vehicle 105. The prerequisite for this is that the public key 180 of the device 110 has been transferred from the memory 155 of the security device 150 to the memory 145 of the apparatus 120. This transfer can take place periodically, for example each time the motor vehicle 105 is started. However, the private key 175 of the motor vehicle 105 is not made available to the apparatus 120 for security reasons.

The apparatus 120 can perform only a one-sided authentication with the device 110. It is proposed that the loss of protection against tracking due to the lack of authentication of the motor vehicle 105 to the device 110 be compensated for by authenticating the user 115 to the device 110. It is also preferable that the user 115 agrees to the performance of the merely one-sided authentication, so that they can decide for themself whether to accept the lower level of protection.

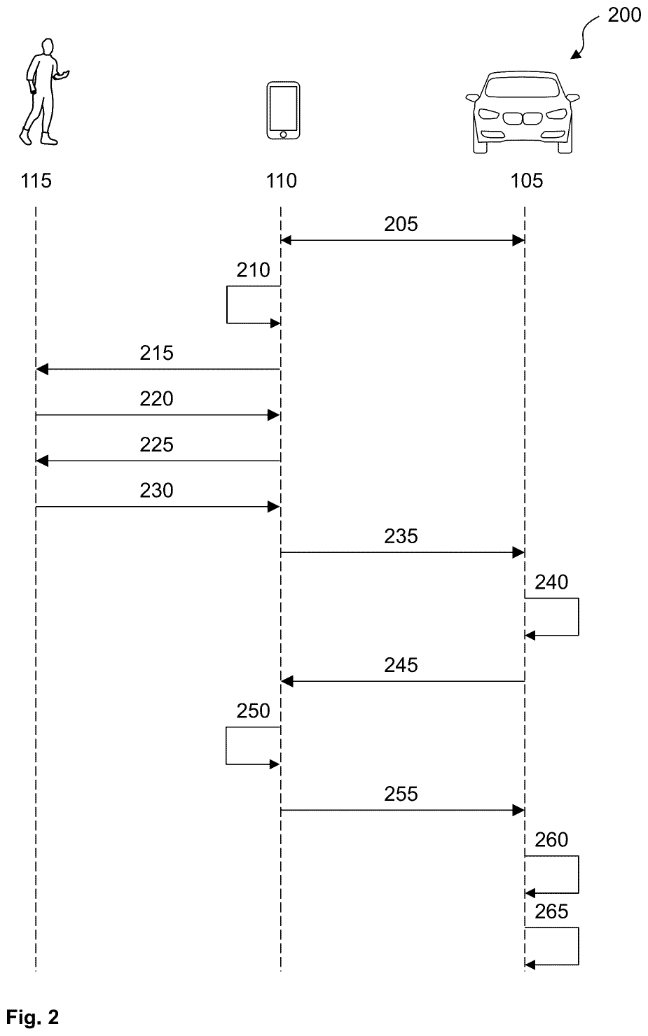

FIG. 2 shows a flowchart of a method 200 for controlling the motor vehicle 105. At the beginning of the method 200, it is assumed that the motor vehicle 105 is parked and that the public key 180 of the device 110 is present in the memory 145 of the apparatus 120. The key 180 is usually stored in the memory 155 of the security device 150 by means of a predetermined exchange protocol if access to the motor vehicle 105 is to be permitted. The stored key 180 can be synchronized into the memory 145 of the apparatus 120 periodically or in an event-driven manner. Synchronization can, for example, always take place when the motor vehicle 105 is being parked or prepared, or whenever a predetermined duration or operating time of the motor vehicle 105 has elapsed.

In a step 205, wireless communication is established between the device 110 and the motor vehicle 105. In a step 210, the device 110 may determine a failure to authenticate the motor vehicle 105. This can be understood by the apparatus 120 to be an indication that the security device 150 is not available and that a normal method of accessing the motor vehicle 105 using two-sided authentication cannot be carried out.

In a step 215, the user 115 may be asked by the device 110 for consent to carry out a one-sided authentication. It may therefore be explained to the user 115 that a normal authentication is not possible because the security device 150 of the motor vehicle 105 does not appear to be available. A consent of the user 115 for one-sided authentication may be recorded by the device 110 in a step 220. Optionally, a transaction intention can also be determined, i.e. a function that is to be controlled by the apparatus 120 if the subsequent one-sided authentication is successful. This function can include, for example, locking or unlocking a door, a hatch or a window. In a further embodiment, a service function of the motor vehicle 105 can also be activated, for example switching off an alarm system or enabling the motor vehicle 105 to be towed away, for example by releasing a parking lock.

To carry out the one-sided authentication between the motor vehicle 105 and the device 110, an authentication of the user 115 to the device 110 may be carried out in a step 225. This authentication can be performed, for example, by entering a code, by the user performing a secret gesture or by presenting a biometric feature of the user 115.

In a step 230, the authentication of the user 115 may be determined to have been successful. The authentication may be performed by an immutable software component of the device 110. The software component may be part of an operating system of the device 110. The authentication of the user 115 subsequently allows a digital key in the memory 112 to be accessed. If the authentication of the user 115 fails, the method 200 cannot be continued.

In a step 235, a request to perform a one-sided authentication may be transmitted from the device 110 to the motor vehicle 105. The request may identify a control function to be performed by the apparatus 120 after the one-sided authentication. The control function can include, for example, unlocking a door of the motor vehicle 105.

In a step 240, the apparatus 120 may determine a lack of availability of the security device 150. This step is preferably carried out by means of the processing device 135. If the security device 150 is available, the one-sided authentication can be denied by the apparatus 120. In this case, the method 200 can terminate at this point.

Otherwise, in a step 245, a challenge may be determined by the apparatus 120 as part of a challenge-response authentication, for example based on a random value. Systematic information can optionally be added to the challenge, for example an identification of the motor vehicle 105.

In a step 250, the challenge may be signed by the device 110. For this purpose, a cryptographic extract of the challenge (message digest) can be formed, preferably in the form of a hash value, for example MD5 or preferably Secure Hash Algorithm (SHA-256) as part of the Elliptic Curve Digital Signature Algorithm (ECDSA). The resulting value can be encrypted using the public key 170 of the motor vehicle 105. This may result in a signature that can be transmitted to the motor vehicle 105 as a response in a step 255.

The response can be checked by the motor vehicle 105 in a step 260. For this purpose, the received signature can be compared with a locally created signature of the previously sent challenge. If the data match, the device 110 is successfully authenticated to the motor vehicle 105.

In this case, the request from step 235 can be complied with in a step 265 after performance of the predetermined control function. If no control function has been explicitly requested, a predetermined control function can be performed. The control function can include activation of the control apparatus 125 via the interface 130.

As a result, even if the security device 150 of the motor vehicle 105 is not available, the user 115 can gain access to the motor vehicle 105 by holding the device 110 close enough to the wireless interface 140 of the apparatus 120 and helping to perform the method 200. A sufficiently high level of security can be achieved by the one-sided authentication with regard to preventing unauthorized use of the motor vehicle 105 or triggering of the control function.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SIGNS

100 System
105 Motor vehicle
110 External device, mobile device, smartphone, smart watch
112 Memory
115 User
120 Apparatus
125 Control apparatus
130 Interface
135 Processing device
140 Wireless interface
145 Memory
150 Security device
155 Memory
160 On-board power supply
170 Public key of the motor vehicle
175 Private key of the motor vehicle
180 Public key of the device
185 Private key of the device
200 Method
205 Wireless communication between the device and the motor vehicle
210 Determine failure to authenticate the motor vehicle
215 Obtain the user's consent
220 Record consent/control function
225 Authentication of the user to the device
230 Authentication successful
235 Request for one-sided authentication
240 Determine lack of availability of the security device
245 Challenge
250 Sign
255 Response
260 Check
265 Control

What is claimed is:

1. An apparatus for controlling a motor vehicle, the apparatus comprising:
a wireless interface for communicating with an external device;
a memory in which a public digital key of the device is stored;
an interface to a control apparatus of the motor vehicle;
a processing device which is configured to:
detect a request from the device for one-sided authentication;
perform an authentication of the device to the motor vehicle on the basis of the stored digital key; and
activate the control apparatus if the authentication is successful.

2. The apparatus according to claim 1, wherein a challenge-response authentication of the device to the motor vehicle is carried out.

3. The apparatus according to claim 1, wherein the control apparatus is configured to control a predetermined vehicle function.

4. The apparatus according to claim 1, wherein the control apparatus is configured to control a physical entry to an interior of the motor vehicle.

5. The apparatus according to claim 1, wherein the wireless interface comprises an NFC interface.

6. The apparatus according to claim 5, wherein the apparatus is configured to be operated by electrical energy received via the NFC interface.

7. The apparatus according to claim 1, further comprising:
an interface to a security device that is configured to authenticate the motor vehicle to the device, wherein
the processing device is further configured to:
waive an authentication of the motor vehicle to the device if the security device is not available.

8. The apparatus according to claim 7, wherein
the authentication of the motor vehicle to the device precedes an authentication of the device to the motor vehicle if the security device is available.

9. The apparatus according to claim 7, wherein
the control apparatus is configured to operate independently of the security device.

10. A motor vehicle comprising an apparatus according to claim 1.

11. A mobile device with a wireless interface, wherein the mobile device is configured to:
use the wireless interface to send a request for one-sided authentication to an apparatus for controlling a motor vehicle;
authenticate a user to the mobile device;
receive a challenge from the apparatus;
determine a response based on a private digital key; and
transmit the response to the apparatus.

12. The mobile device according to claim 11, further comprising:
a secure memory in which the private digital key is stored, wherein
the mobile device is further configured to permit access to the key only after successful authentication of the user.

13. A system, comprising:
(i) an apparatus for controlling a motor vehicle, the apparatus comprising:
a wireless interface for communicating with a mobile device;
a memory in which a public digital key of the mobile device is stored;
an interface to a control apparatus of the motor vehicle;
a processing device which is configured to:
detect a request from the mobile device for one-sided authentication;
perform an authentication of the mobile device to the motor vehicle on the basis of the stored digital key; and
activate the control apparatus if the authentication is successful;
(ii) the mobile device with a wireless interface, wherein the mobile device is configured to:
use the wireless interface to send a request for one-sided authentication to the apparatus for controlling the motor vehicle;
authenticate a user to the mobile device;
receive a challenge from the apparatus;
determine a response based on a private digital key; and
transmit the response to the apparatus.

14. A method of controlling a motor vehicle, the method comprising the steps of:
establishing a wireless connection between the motor vehicle and an external device;
authenticating a user to the external device;
one-sided authentication of the external device to the motor vehicle; and
controlling the motor vehicle upon authentication.

15. The method according to claim 14, wherein the authenticating of the user permits access to a private digital key of the device and the key is used for the one-sided authentication.
